(19) United States
(12) Patent Application Publication
(10) Pub. No.: US 2009/0277594 A1
(43) Pub. Date: Nov. 12, 2009

(54) ACOUSTIC WINDOW SHADE

(76) Inventors: Grant W. Stewart, Cincinnati, OH (US); James F. Cissell, Walton, KY (US)

Correspondence Address: Hasse & Nesbitt LLC, 8837 Chapel Square Drive, Suite C, CINCINNATI, OH, 45249, US

(21) Appl. No.: 12/432,336

(22) Filed: Apr. 29, 2009

Related U.S. Application Data
(60) Provisional application No. 61/051,969, filed on May 9, 2008.

(51) Int. Cl. E06B 9/68; A47G 5/02; A44B 18/00; G10K 11/16

(52) U.S. Cl. 160/311; 160/309; 24/442; 181/211

(57) ABSTRACT

A window shade system comprising a roller tube, a top casing, and a shade having a first end engaged with the roller tube and a second end engaged with the top casing such that the shade forms a bight between its ends that separates the shade into a front portion and a back portion. A rod is disposed in the bight. A lift mechanism, typically a motor, rotates the roller tube and moves the shade between a raised position where the bight is adjacent the top casing and a lowered position where the bight is distanced from the top casing. When the shade is in the lowered position, the front portion of the shade comprises a decorative fabric layer and the back portion comprises a sound attenuating layer, such as a polymer film with filler material or mass loaded vinyl. The window shade system typically comprises side casings that have channels for receiving the side edges of the shade.

### CROSS-REFERENCE TO RELATED APPLICATIONS

This application claims the benefit of co-pending U.S. Provisional Application No. 61/051,969, filed May 9, 2008.

### FIELD OF THE INVENTION

This invention relates to an acoustic window shade. More particularly, the invention relates to a window shade for use on a roller tube, the shade having a front portion comprising a decorative fabric layer and a back portion comprising a sound attenuating layer. The invention also relates to a window shade system comprising such an acoustic window shade.

### BACKGROUND OF THE INVENTION

Window shade systems are desirable to reduce or eliminate light from entering a room through a window or a skylight, particularly in a home theater or a conference room used for film viewing. Numerous shade systems are disclosed in the art. Typically, the shades of such systems are unrolled from a roller in a casing affixed to the top of the window opening. The roller may be controlled by a motor inside the casing, a manually operated crank, or a bi-directional clutch having a chain affixed thereto. The shade may comprise various materials and have varied textures and light admitting properties. Shade systems are disclosed in, for example, U.S. Pat. Nos. 5,323,831; 5,467,266; 5,848,634; and 6,189,592.

In a home theater or conference room setting, the quality of sound from both the presentation itself and the immediate environment is important to the listener's enjoyment and appreciation of the presentation. The benefits of a quality sound system in a home theater or conference room can be reduced by sound bouncing back into the listening space from walls and windows, and by outside sound coming into the environment through windows. When radiant sound can be absorbed in such areas, rather than echoing back in conflict with sounds from the presentation, negative issues can be reduced or eliminated altogether. This is sometimes achieved by covering walls and windows with an acoustically absorbent material. Walls are often also widened with extra insulation and double sheet rock to form a sound barrier from external noise. In the case of windows, heavy draperies or window shades having soft or thick fabrics may aid in sound absorption, although shades using industry standard fabrics and materials typically have little or no measurable effect. Window shading also provides outside light control or blockage, which is important to appreciate visual aspects of a presentation. Window roller shades are generally more practical and desirable than draperies, primarily because of physical space limitations and aesthetic tastes or requirements. Additionally, window roller shades tend to allow better control of outside light because of more latitude in positioning shades and fabric options.

In view of the above, it would be desirable to provide a window shade and system for home theaters and conference rooms that would measurably reduce both the echo effect of sound bouncing back into the listening space from walls and windows and outside sound coming into the environment through the windows.

### SUMMARY OF THE INVENTION

The present invention relates to a window shade system comprising a roller tube; a top casing; a shade having opposed first and second side edges defining its width and opposed first and second ends, the first end being engaged with the roller tube and the second end being engaged with the top casing such that the shade forms a bight between its ends that separates the shade into a front portion extending from the bight to the second end of the shade and a back portion extending from the bight to the first end of the shade; a rod disposed in the bight; and a lift mechanism coupled to the roller tube to selectively rotate the roller tube and thereby move the shade between a raised position where the bight is adjacent the top casing and a lowered position where the bight is distanced from the top casing; wherein when the shade is in the lowered position, the front portion comprises a decorative fabric layer and the back portion comprises a sound attenuating layer.

The invention also relates to window shade system as described above in which the lift mechanism includes a motor operatively connected to the roller tube such that the roller tube rotates about its longitudinal axis in response to the operation of the motor, and further comprising first and second side casings attached to the top casing, each side casing having a channel for receiving the opposed side edges of the shade as it moves between the raised position and the lowered position, and a bottom casing attached to the side casings and having a channel for receiving the rod disposed in the bight when the shade is in the lowered position.

### BRIEF DESCRIPTION OF THE DRAWINGS

FIG. 1 is a perspective view of a window shade system of the invention viewed from inside a room in which the shade system is installed within a window opening.

FIG. 2 is an enlarged, cut-away view of a lower portion of the window shade system shown in FIG. 1.

FIG. 3 is a perspective view of a portion of the window shade system of FIG. 1 viewed from outside a room in which the shade system is installed, and with the back portion of the shade partially cut away.

FIG. 4 is an enlarged, cut-away perspective view of a portion of the window shade system of FIG. 1 viewed from outside a room in which the shade system is installed.

FIG. 5 is a perspective view of a portion of the window shade system of FIG. 1 viewed from outside a room in which the shade system is installed, with the shade in a partially raised position.

FIG. 6 is a perspective view of a window shade system of the invention viewed from inside a room in which the shade system is installed by mounting it on the wall surrounding the window.

### DETAILED DESCRIPTION OF THE INVENTION

The window shade of the present invention is designed for use with a window shade system comprising an operable roller tube for rolling and unrolling the shade. The window shade has opposed first and second ends, the first end being engaged with the roller tube and the second end being engaged with the top casing. The shade forms a bight between its ends that separates the shade into a front portion extending from the bight to the second end of the shade and a back portion extending from the bight to the first end of the shade. When the shade is in the lowered position, the front portion comprises a decorative fabric layer and the back portion comprises a sound attenuating layer. These and other features of the invention will be explained with reference to the accompanying drawings, which illustrate non-limiting embodiments of the invention.

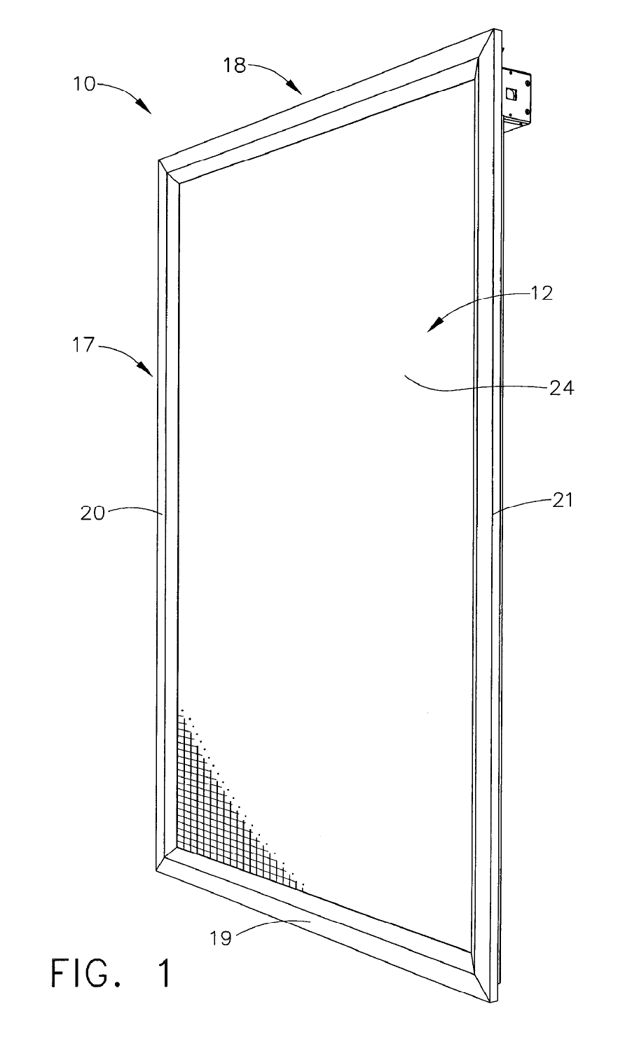

FIG. 1 is a perspective view of a window shade system 10 of the invention viewed from inside a room in which the shade system is installed within a window opening (not shown) having a top portion, a bottom portion opposite the top portion, and first and second opposing sides. Shade system 10 includes shade 12 in a fully lowered position and mounted within casing 17. Casing 17 comprises top casing 18, bottom casing 19, and first and second side casings 20 and 21. The top casing and the bottom casing are attached to the side casings. The window shade system, particularly the casing, may be mounted to the respective portion or side of the window opening or interior wall face, either as an “inside mount” or “outside mount” system. As used herein, “inside mount” refers to a shade system mounted primarily within the framework of a window, and typically recessed at least two inches from the face of the interior wall. “Outside mount” refers to a shade system mounted on the interior wall face surrounding the window, rather than within the window recess. While the casing may be made of various materials, including metal, wood and plastic materials, in one embodiment the casing is made of extruded aluminum. In another embodiment, the window shade system is mounted to the window opening as an integral unit, as hereinafter described.

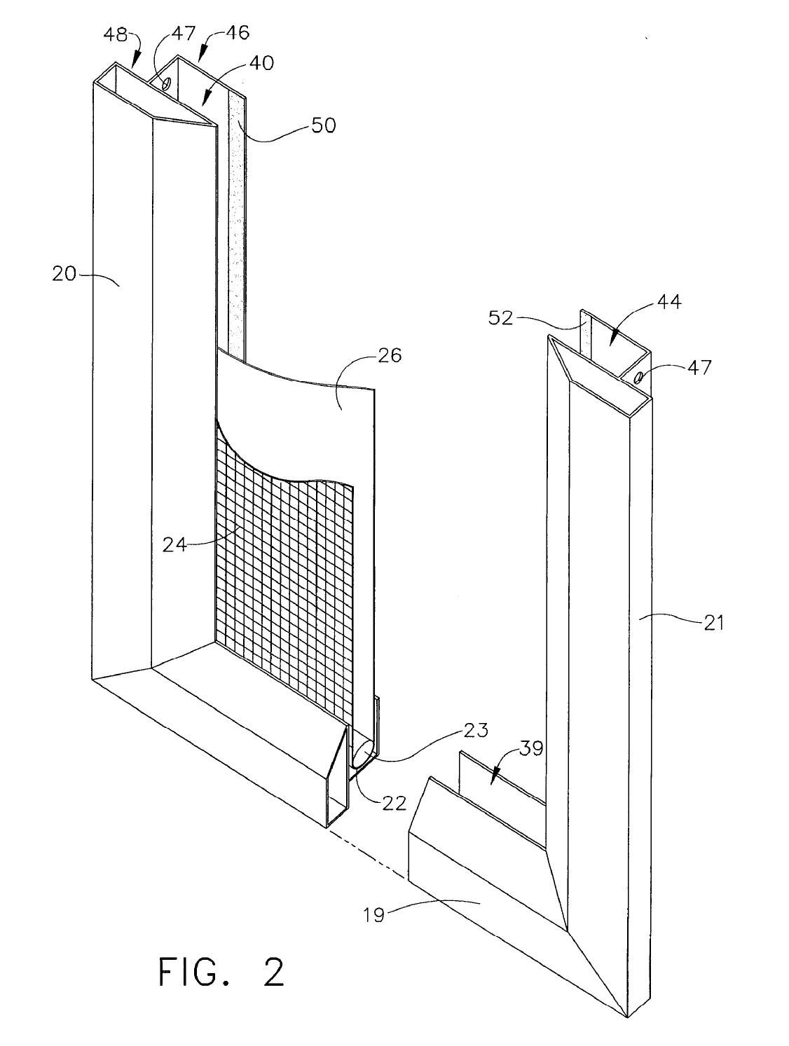

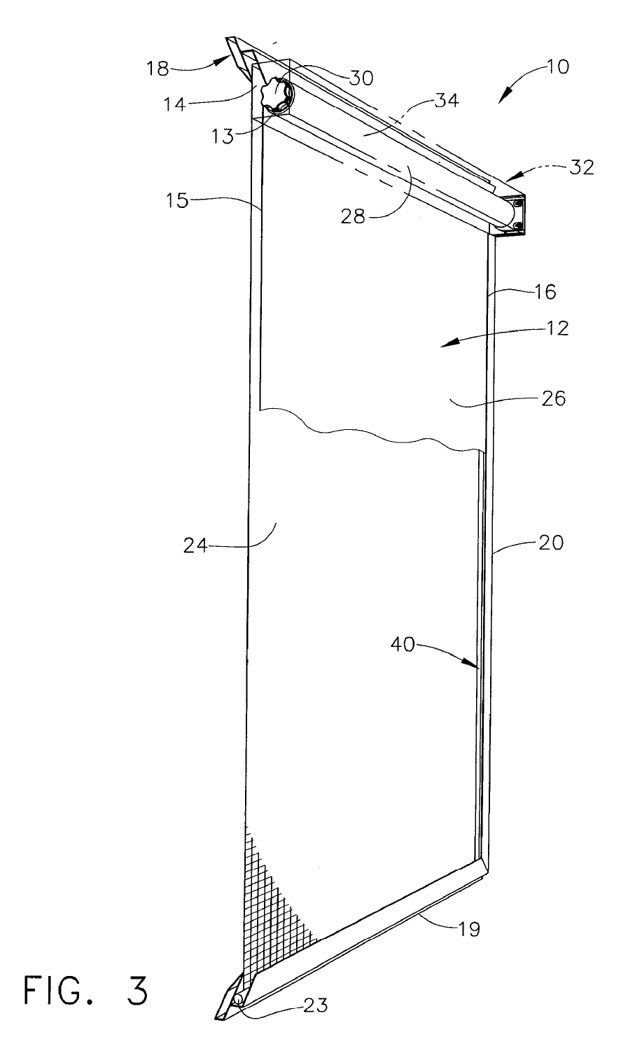

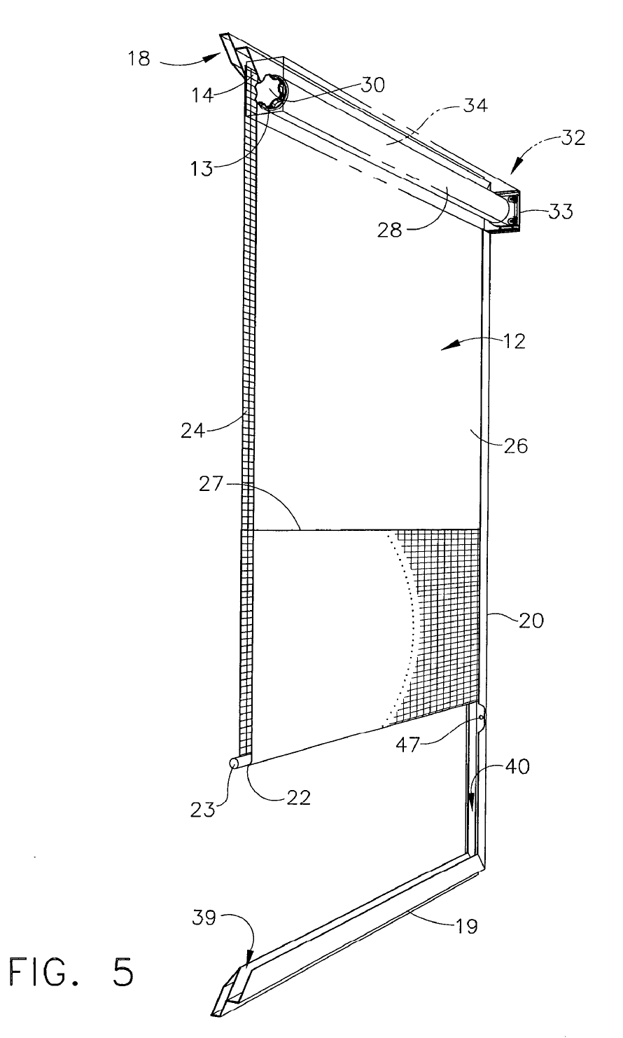

FIG. 3 is a perspective view of a portion of the window shade system of FIG. 1 viewed from outside the room in which the shade system is installed, and with the back portion of the shade partially cut away. Shade system 10 includes a shade 12, which is a flexible sheet having a first end 13 connected to roller tube 28, an opposed second end 14 opposite the first end and connected to top casing 18, and first and second opposing side edges 15, 16 that define the width of the shade. Shade 12 forms a U-shaped bight 22 (shown in FIGS. 2 and 5) between its ends that separates the shade into a front portion 24 extending from the bight to the second end 14 of the shade and a back portion 26 extending from the bight to the first end 13 of the shade. Bight 22 is the lower-most part of shade 12 in the assembled shade system 10. To weight the shade and keep it taught and stable in the assembled shade system, a solid or hollow cylindrical rod 23 is disposed in bight 22. The rod may be made of any suitable material, for example metal, glass, fiberglass, ceramic or plastic. As the shade is moved between the raised and lowered positions, the rod rolls with minimal friction on the shade within the bight. In one embodiment, the rod is a solid cylindrical stainless steel bar having a diameter of about 0.75 inches.

The front and back portions 24, 26 of the shade are parallel planar sheets that face each other. In one embodiment, the front and back portions are contiguous, with the boundary between them essentially being established by bight 22. The distance between the front and back portions of the shade may be varied to fit particular design and acoustical requirements, and may range, for example, from 0.1 inches to 2 or 3 inches. However, the front portion of the shade is typically separated from the back portion by a distance of from about 0.25 inches to about 1.5 inches, more typically from about 0.5 inches to about 1 inch, for example about 0.75 inches. When the shade is in the lowered position, the front portion 24 comprises a decorative fabric layer and the back portion 26 comprises a sound attenuating layer, as hereinafter described. The decorative fabric layer is typically seamed to the sound attenuating layer, such as by seam 27 shown in FIG. 5, to form a continuous sheet comprising at least two different materials. The back portion of the shade may also comprise decorative fabric material, and the front portion of the shade may also comprise sound attenuating material.

The first end 13 of shade 12 is attached to roller tube 28 using any means known in the art, for example by using adhesive tape, double-sided adhesive tape, glue, staples, screws or other fasteners. Roller tube 28 may be made from any material that is sufficiently rigid to support the weight of a shade, such as aluminum, steel, or carbon composite. Roller tube 28 is cut to an appropriate length depending on the size of the window opening. In one embodiment, the roller tube is a section of 2-2.25 inch diameter aluminum alloy tubing. In large window applications, the tube diameter may be as large as 4-8 inches, or more. In the embodiment shown in FIGS. 3-5, the shade 12 rolls off the front of roller tube 28 in what is commonly referred to as a “forward roll” configuration. However, the shade system of the invention may also be designed such that the shade rolls off the back of the roller tube in a “backward roll” configuration.

Shade system 10 includes a lift mechanism, such as motor 30 shown in FIGS. 3-5, coupled to the roller tube 28 to selectively rotate the roller tube and raise and lower the shade by moving it between a raised position where the bight 22 is adjacent the top casing 18 and a lowered position where the bight is distanced from the top casing. Roller tube 28 is operatively connected to motor 30 such that the roller tube rotates about its longitudinal axis in response to the operation of the motor. Rotation of the roller tube by the motor causes shade 12 to be raised and lowered with respect to top casing 18. The shade is thus movable between a rolled condition in which it is at least substantially rolled up onto roller tube 28 and an unrolled condition in which it at least substantially covers the window opening. Typically, the shade may be stopped at any position between the rolled and unrolled positions at the discretion of the operator.

When the shade is being raised or lowered, the front portion 24 and back portion 26 of the shade move relative to each other. As the shade is raised or lowered, the bight is correspondingly raised or lowered and, consequently, the area of the front portion correspondingly grows smaller or larger, as can be seen in FIG. 5. Shade 12 can be raised and lowered from top casing 18 such that the ends of the rod 23 and the first and second opposing side edges 15, 16 of the shade are slidably movable within vertical channel 40 of first side casing 20 and vertical channel 44 of second side casing 21 (see FIG. 2). When the shade is fully lowered to engage bottom casing 19, rod 23 resides within horizontal channel 39 of the bottom casing. The vertical channels in the side casings and the horizontal channel in the bottom casing provide additional blockage of light, sound, heat and/or cold coming from the exterior of the window space.

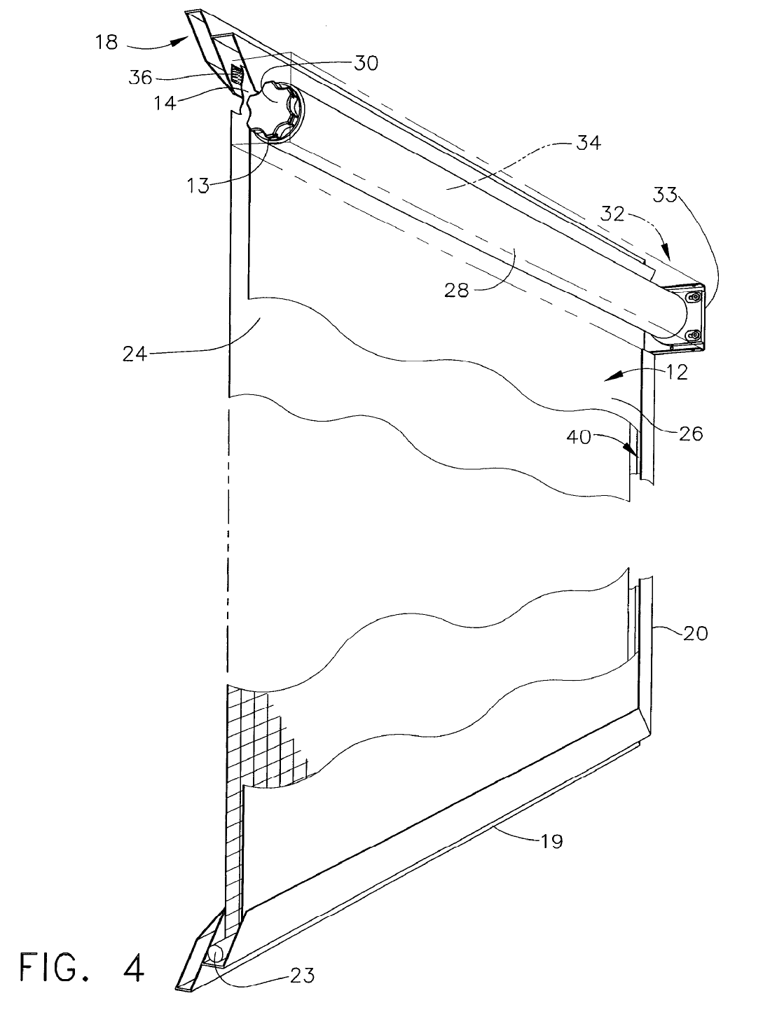

As shown in FIG. 4, the top casing 18 includes a housing 32 that encloses the roller tube 28 and motor 30. The housing includes a first end cap 33 and an opposed second end cap (not shown), and opposed front and back cover plates 34 extending between the end caps. The roller tube is rotatably engaged with at least one of the end caps at one end of the roller tube. The other end of the roller tube is engaged with the motor, using various means known in the art. In one embodiment, the motor is mounted to one end cap through a motor bracket and a mounting bracket. The idler end of the roller tube is mounted to the other end cap through an idler bracket and mounting bracket.

As shown in FIGS. 3-5, the second end 14 of shade 12 is fastened to top casing 18, and in particular, to the front cover plate 34 of housing 32. In the embodiment shown in FIG. 4, the second end 14 of the shade is removably attached to the back side of front cover plate 34 by means of a hook and loop (e.g., Velcro) fastening system 36. For example, a strip of hook material may be sewn onto the second end 14 of the shade, and a strip of loop material attached to the back side of the front cover plate 34 with an adhesive material. Such a hook and loop fastening system allows easy removal and/or adjustment of the shade with respect to the front cover plate, while at the same time providing secure attachment thereto. In other embodiments, the second end 14 of the shade may be engaged with other portions of top casing 18. For example, the top casing may comprise a mounting tube supported by end caps such as end cap 33. The mounting tube can be received on support pins on the end caps in an interference fit that is sufficiently tight to prevent the tube from rotating during normal operation, while allowing a person to manually rotate the tube to establish the length of the shade in the fully lowered position as appropriate for the particular window being covered. The mounting tube is “stationary” in that it does not move during normal operation of the shade. It can readily be appreciated that with the first end of the shade engaged with the roller tube, and the second end of the shade engaged with the mounting tube or other portions of the top casing, the shade hangs downwardly from the top casing to form the bight between the ends of the shade.

Motor 30 may receive control signals from any suitable source such as an infrared (IR) or radio frequency (RF) remote control or a low-voltage wall control unit. The motor is typically powered from a conventional 120 volt ac wall receptacle, and may be hardwired within a junction box, or to a building distribution panel, or through a 120:24 transformer. Alternatively, the lift mechanism may include a dc motor that is selectively energized by one or more dc alkaline or lithium primary batteries. The motor may be gearedly coupled to a collar that fits snugly within a complementarily configured channel of the roller tube in stationary engagement therewith, such that when the motor is energized the roller tube is rotated. In another embodiment, the lift mechanism may be a manually operated device such as a conventional clutch mechanism that is engaged in accordance with conventional principles with the roller tube to rotate the tube and thereby lift or lower the shade.

To help retain the rod 23 in the bight 22, left and right rod ends caps may be positioned in or on the ends of the rod. Alternatively, the rod can be suspended from the top casing 18 by suspension lines (not shown), the length of which is about equal to the distance from the top casing to the bight when the shade is in the lowered position. In the embodiment shown in FIGS. 2-5, the ends of the rod are slidably engaged with vertical channels 40, 44 to hold the shade in a relatively stationary position. If desired to hold the front portion 24 and back portion 26 of the shade close together when the shade is lower than about midway between the raised and lowered positions, two parallel spacing bars or rollers may be affixed to the rod 23 at the respective ends of the bars or rollers and the rod. The bars or rollers hold the front portion and back portion of the shade close together while allowing for the rod 23 to pass between the bars or rollers.

The above-described relative motion between the front and back portions of the shade 12 may be used to alter the opacity of the shade. In one embodiment, the front portion 24 of the shade is perforated and the back portion 26 is not perforated, such as shown in FIGS. 1-5. As the shade is raised from the lowered position, it moves from a high opacity configuration in which essentially no light, or a relatively small amount of light per unit area, can pass through the shade, as in FIG. 1, to a lower opacity configuration in which more light, up to a relatively large amount of light per unit area, can pass through the shade, as in FIG. 5. The perforated front portion of the shade thus allows limited (e.g., minimal) through-visibility to whatever is behind it, whether a perforated portion of the shade such as shown in FIG. 5 or the sound attenuation layer. This visual affect will vary depending on outside light coming into the window area, as well as the colors and fabrics used in the front and back portions of the shade.

In another embodiment, the shade may comprise alternating at least first and second strips, each having a width, which may be the same or different. The strips may have designs on them, e.g., dark, opaque diagonal lines may he printed, deposited, or otherwise formed on the first strips such that they are characterized by relatively high opacity. The second strips may be characterized by relatively low opacity, e.g., they may be made of colored translucent material or clear transparent material. To increase the opacity of the shade when it is in the high opacity configuration, the first (i.e., relatively opaque) strips may have widths that are greater than the widths of the second (i.e., less opaque) strips. As the shade is raised and lowered, the strips of the front portion of the shade are moved upwardly and downwardly relative to strips on the rear portion of the shade, and the opacity of the shade may be varied as the shade is moved between a raised position and a lowered position.

The window shade system herein can be mounted adjacent to or within any window opening, including a skylight opening, in a wall, ceiling and the like. It can be disposed at an angle to horizontal or vertical. In such angled or horizontal applications, the shade hardware can be modified to meet design requirements, as known in the art. A single window shade system is shown in the drawings, but multiple shade systems can be mounted side-by-side, for example over a corresponding group of adjacent windows. It will also be appreciated that other mechanisms, such as a hand crank or a bi-directional clutch, may be utilized for raising and lowering the shade, and that such mechanisms are within the scope of the present invention.

The shade system of the present invention may be installed in a window opening in a traditional manner in which the various individual components are separately installed. For example, shade mounting brackets, end caps, roller tube assembly, shade, cover plates, and other portions of the housing for the roller tube assembly, and top, bottom and side casings may be installed in the window opening as separate pieces. Depending on the size, quantity and complexity of the job, installation of such roller shade systems can be a time consuming process. However, in one embodiment, the window shade system is installed into or on its predetermined location as a single unit, eliminating the need for the installer to deal with the separate components. Such an integral window shade system may be fully pre-assembled by the manufacturer according to customer's ordering specifications. The shade installer simply removes the shade system from its shipping container, sets the shade system into place in or over the window opening, secures it to the window frame or wall surrounding the window opening with the appropriate mounting screws or fasteners (e.g., through openings in the top, bottom and/or side casings), and connects the motor and roller tube assembly to any necessary electrical and/or control wiring in the room. The shade is fully operable at that point, allowing for any necessary adjustments.

As described above, the window shade system of the invention is designed to accommodate both “inside” and “outside” mounting requirements, with different style frames accordingly. In one embodiment, each side casing, and typically also the bottom and/or top casing, has a plurality of holes for receiving fasteners for mounting the shade system to the window frame or the wall. For the inside mount system shown in FIGS. 1-5, the interior portion 46 of casing 17 (see FIG. 2) is made to fit inside the recess of the window framing (all four sides) with minimal clearance (e.g., 0.25 inches is a typical maximum clearance). Predrilled holes, such as holes 47, in the interior portion 46 of the casing (e.g., in the side walls perpendicular to the window opening) allow the installer to secure the shade system within the window framing using screws of appropriate type and length. A flange 48 extends around the perimeter of the casing 17 (including the top casing, side casings and bottom casing) to prevent the shade system from being pushed too far into the window recess or opening, ensure even depth spacing, and visually finish the completed installation by eliminating the visibility of the gap between the interior portion of the casing and the window frame when viewed from the interior of the room. The back cover plate 34 (see FIGS. 3-5) covers the roller tube 28 and hides visibility of the roller tube from the outside of the window (building exterior). The side edges 15, 16 of the shade travel up and down within vertical channels 40, 44, preventing outside light from coming through the otherwise unblocked area while at the same time helping to block transmission of some exterior sound (noise), heat and/or cold. To ensure a tight seal between the shade and the side casings, thin strips of magnetic paint (not shown) may be applied to the back side of the back portion of the shade near its side edges and magnetic strips 50, 52 attached to the corresponding portions of the side casings, as shown in FIG. 2.

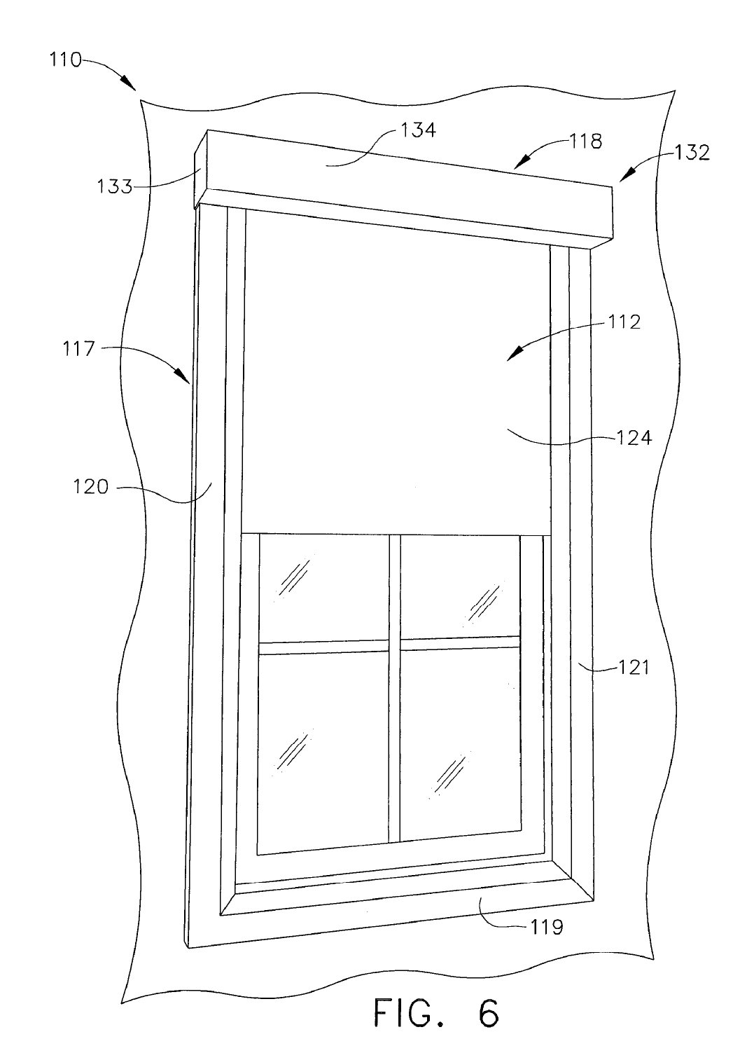

FIG. 6 is a perspective view of a window shade system 110 of the invention viewed from inside a room in which the shade system is installed over a window opening having a top portion, a bottom portion opposite the top portion, and first and second opposing sides. Shade system 110 is installed by mounting it on the wall face surrounding the window, i.e., an “outside mount” system. Shade system 110 is otherwise similar to shade system 10 shown in FIGS. 1-5. Casing 117 comprises top casing 18, bottom casing 119, and first and second side casings 120 and 121. The top casing and the bottom casing are attached to the side casings. The shade system includes shade 112 in a partially lowered position and mounted within casing 117. Top casing 118 includes a housing 132 that encloses the roller tube (not shown) and a motor to operate the roller tube. The housing includes a first end cap 133 and an opposed second end cap (not shown), and opposed front and back cover plates 134 extending between the end caps. Shade 112 is a flexible sheet having a first end connected to the roller tube, an opposed second end opposite the first end and connected to top casing 118, and first and second opposing side edges that define the width of the shade. Shade 112 forms a U-shaped bight between its ends that separates the shade into a front portion 124 extending from the bight to the second end of the shade and a back portion (not shown) extending from the bight to the first end of the shade. To weight the shade and keep it taught and stable in the assembled shade system, a solid or hollow cylindrical rod is disposed in the bight. While the casing may be made of various materials, including metal, wood and plastic materials, in one embodiment the casing is made of extruded aluminum. In another embodiment, the window shade system is mounted to the wall face surrounding the window opening as an integral unit, as described above.

The window shade of the present invention comprises a decorative fabric layer and a sound attenuating layer. The front portion of the shade comprises the decorative fabric layer, which may be any suitable fabric, and typically has a size up to about 3.3 meters by 3.3 meters with a maximum fabric weight per motor of about 4.5 kilograms. Of course, larger fabric sizes may be accommodated by means of a motor drive unit capable of generating more torque. A suitable fabric is standard stock from 3G Mermet, although other similar fabrics can be used. In another embodiment, the decorative fabric layer is a perforated fabric commercially available as View from Sunbrella/Glenraven Industries. The fabric layer may comprise one or more nonwoven fibrous sheets or other suitable materials, as a single-layered or multiple-layered laminate-type composite.

The sound attenuating layer of the back portion of the shade may comprise a polymer matrix, for example a polymer firm, and a filler material, such as disclosed in WO 2008/021455 A2, incorporated herein by reference. The matrix material may include polymers and polymeric resins, aerogels, nonwoven fibrous materials, or combinations of the foregoing. Suitable polymers and polymeric resins may include polymers currently used for sound absorption applications such as open celled foamed polymers, polyurethanes, polyimides, polycyanurates, polyesters and melamine.

Other suitable polymer and polymeric resins include, but are not limited to, polystyrene, polyurethane, polyolefins such as polyethylene or polypropylene, hydrogels, polyacrylates, polyarylenes, polycarbonates, polyureas, polycyanurates, polysulfones, epoxies, nylons, aramids, polyvinyl chloride, polymers of (meth)acrylic acid or the esters and/or salts of (meth)acrylic acid, polyesters, rubber, PTFE, silicone, and mixtures of two or more of any of the foregoing. The polymer may also be a polymer of one or more of the monomers comprising the polymers of the foregoing. For example, the polymer may be a copolymer of styrene and acrylonitrile.

Another polymer medium that can be used is hydrogel. Hydrogel is a network of polymer chains that are water-soluble, sometimes found as a colloidal gel in which water is the dispersion medium. Hydrogels can be created in may ways, and is not limited to any one particular method of formation. For example, the hydrogels may be made of one or more materials selected from the group consisting of polyvinyl alcohol, sodium polyacrylate, (meth)acrylate polymer, and other polymers with an abundance of hydrophilic groups. Preferred hydrogels include 2-hydroxyethylmethacrylate (HEMA) hydrogels, but are not limited thereto. Another suitable hydrogel material includes N-vinyl-pyrrolidone (NVP).

Cross linkers may also be used in the polymers. For example, ethylene glycol dimethacrylate (EDGMA) may be used. Another example of a cross linker is polyethylene glycol dimethacrylate (PEDGMA). Photoinitiators, such as 2,2-dimethoxy-2-phenyl acetophenone, may also be used. In some embodiments, the photoinitiator may help assist in the reaction of the polymerization and/or curing of the polymers. For example, UV irradiation of a polymer comprising 2,2-dimethoxy-2-phenyl acetophenone results in the curing of the polymer composite material.

Filler materials herein include a non-reactive material with a high density, typically greater that 1 g/cm³, and more typically from about 2.0 to about 3.0 g/cm³. The filler material may be chosen for any non-reactive material with a high density such as, for example, barium sulphate, kaolin clay, silica, mica, microscopic hollow glass beads, or mixtures thereof.

In another embodiment, the sound attenuating layer comprises a mass-loaded vinyl material. Such materials are commercially available and can be made in varying levels of opacity (clear, semi-opaque or non-transparent), as desired, for more or less light transmission into the structures. A suitable material is American Mass Loaded Vinyl, distributed by Soundproofing America. Those skilled in the art will understand that many types of materials may be used.

In one embodiment, the sheet is a laminate of the decorative fabric layer and the sound attenuating layer. In another embodiment, the sound attenuating layer may be coated onto the decorative fabric layer, for example, by spraying, coating, or otherwise depositing a slurry, solution, emulsion, or mixture of the sound attenuating material onto the fabric and then drying the fabric to remove water and/or solvents, or simply allowing the material to cool and solidify. In another embodiment, the sound attenuating layer may be deposited or laminated as a thin film onto the fabric layer, and then dried or allowed to solidify, as required. Pressure, or a combination of heat and pressure, may be applied to form a laminate, and ultra violet (UV) light may be used as necessary to aid curing or chemical reactions. The above processes may be performed manually. For example, the decorative fabric layer and an acoustic film may be cut to the desired size, and an adhesive applied to each layer using a brush, roller applicator or spray-gun. A suitable adhesive is Weldwood Contact Cement, commercially available from DAP. The layers are then joined together on a bench or work table. The laminate can then be rolled or pressed under pressure using a hand-held rolling device, and left to dry or cure as required. More typically, the above processes are performed using automated equipment designed for such purposes. In an automated process, the laminated sheet may be produced on a bulk, large roll basis, and cut to custom sizes for specific shades as needed.

The window shades and shade systems of the invention provide improved ambient sound absorption due to the acoustical sheet herein, which traps unwanted sound coming in from outside the window area. The invention thus provides a measurable reduction in noise coming into the room through windows in which the acoustic shade is installed. The window shades and shade systems herein, including the decorative fabric layers, also absorb and/or trap unwanted sound inside the room due to the echo effect of sound bouncing back into the listening space from walls and windows. Embodiments of the invention using two separate window shades and a dual roller system may further improve acoustical properties by taking advantage of the air space between the two shades, which has a proven acoustical benefit as well. The window shades and shade systems herein thus provide advantages over conventional roller shade systems for home theater or conference room applications by improving overall room acoustics, in addition to providing traditional light control. The window shades and shade systems herein may also provide aesthetic and other benefits relating to their style, ease of installation, independent control compatibility, and simple mechanical design that limits inherent noise levels during operation.

While particular embodiments of the invention have been described, the invention can be further modified within the spirit and scope of this disclosure. This application is therefore intended to cover any variations, uses or adaptations of the invention using its general principles. Further, the application is intended to cover such departures from the present disclosure as come within known or customary practice in the art to which this invention pertains and which falls within the limits of the appended claims.

What is claimed is:

1. A window shade system comprising:
a roller tube;
a top casing;
a shade having opposed first and second side edges defining its width and opposed first and second ends, the first end being engaged with the roller tube and the second end being engaged with the top casing such that the shade forms a bight between its ends that separates the shade into a front portion extending from the bight to the second end of the shade and a back portion extending from the bight to the first end of the shade;
a rod disposed in the bight; and
a lift mechanism coupled to the roller tube to selectively rotate the roller tube and thereby move the shade between a raised position where the bight is adjacent the top casing and a lowered position where the bight is distanced from the top casing;
wherein when the shade is in the lowered position, the front portion comprises a decorative fabric layer and the back portion comprises a sound attenuating layer.

2. The window shade system of claim 1, wherein the front portion of the shade is separated from the back portion by a distance of from about 0.25 inches to about 1.5 inches.

3. The window shade system of claim 1, wherein the decorative fabric layer is seamed to the sound attenuating layer to form a continuous sheet comprising at least two different materials.

4. The window shade system of claim 1, wherein the lift mechanism includes a motor operatively connected to the roller tube such that the roller tube rotates about its longitudinal axis in response to the operation of the motor.

5. The window shade system of claim 1, further comprising first and second side casings attached to the top casing, each side casing having a channel for receiving the opposed first and second side edges of the shade as it moves between the raised position and the lowered position.

6. The window shade system of claim 5, wherein the top casing includes a housing that encloses the roller tube and at least a portion of the lift mechanism.

7. The window shade system of claim 6, further comprising a bottom casing attached to the side casings and having a channel for receiving the rod disposed in the bight when the shade is in the lowered position.

8. The window shade system of claim 7, wherein the second end of the shade is removably attached to the housing by a hook and loop fastening system.

9. The window shade system of claim 7, further comprising a flange that extends around the perimeter of the top casing, side casings and bottom casing.

10. The window shade system of claim 1, wherein the front portion of the shade is perforated.

11. The window shade system of claim 1 wherein the sound attenuating layer comprises a polymer matrix and a filler material comprising barium sulfate, kaolin clay, silica, mica, microscopic hollow glass beads, or mixtures thereof.

12. The window shade system of claim 1 wherein the sound attenuating layer comprises mass loaded vinyl.

13. A window shade system comprising:
a roller tube;
a top casing;
a shade having opposed first and second side edges defining its width and opposed first and second ends, the first end being engaged with the roller tube and the second end being engaged with the top casing such that the shade forms a bight between its ends that separates the shade into a front portion extending from the bight to the second end of the shade and a back portion extending from the bight to the first end of the shade;
a rod disposed in the bight;
a lift mechanism coupled to the roller tube to selectively rotate the roller tube and thereby move the shade between a raised position where the bight is adjacent the top casing and a lowered position where the bight is distanced from the top casing, the lift mechanism including a motor operatively connected to the roller tube such that the roller tube rotates about its longitudinal axis in response to the operation of the motor;
first and second side casings attached to the top casing, each side casing having a channel for receiving the opposed first and second side edges of the shade as it moves between the raised position and the lowered position; and
a bottom casing attached to the side casings and having a channel for receiving the rod disposed in the bight when the shade is in the lowered position;
wherein when the shade is in the lowered position, the front portion comprises a decorative fabric layer and the back portion comprises a sound attenuating layer.

14. The window shade system of claim 13, wherein the front portion of the shade is separated from the back portion by a distance of from about 0.25 inches to about 1.5 inches.

15. The window shade system of claim 13, wherein the decorative fabric layer is seamed to the sound attenuating layer to form a continuous sheet comprising at least two different materials.

16. The window shade system of claim 13, wherein the top casing includes a housing that encloses the roller tube and the motor, and the second end of the shade is removably attached to the housing by a hook and loop fastening system.

17. The window shade system of claim 13, wherein the front portion of the shade is perforated.

18. The window shade system of claim 13 wherein the sound attenuating layer comprises a polymer matrix and a filler material comprising barium sulfate, kaolin clay, silica, mica, microscopic hollow glass beads, or mixtures thereof.

19. The window shade system of claim 13 wherein the sound attenuating layer comprises mass loaded vinyl.

20. An integral window shade system comprising:
a roller tube;
a top casing;
a shade having opposed first and second side edges defining its width and opposed first and second ends, the first end being engaged with the roller tube and the second end being engaged with the top casing such that the shade forms a bight between its ends that separates the shade into a front portion extending from the bight to the second end of the shade and a back portion extending from the bight to the first end of the shade;
a rod disposed in the bight;
a lift mechanism coupled to the roller tube to selectively rotate the roller tube and thereby move the shade between a raised position where the bight is adjacent the top casing and a lowered position where the bight is distanced from the top casing, the lift mechanism including a motor operatively connected to the roller tube such that the roller tube rotates about its longitudinal axis in response to the operation of the motor;
first and second side casings attached to the top casing, each side casing having a channel for receiving the opposed first and second side edges of the shade as it moves between the raised position and the lowered position; and
a bottom casing attached to the side casings and having a channel for receiving the rod disposed in the bight when the shade is in the lowered position;
wherein when the shade is in the lowered position, the front portion comprises a decorative fabric layer and the back portion comprises a sound attenuating layer.
